(19) United States
(12) Patent Application Publication
(10) Pub. No.: US 2022/0390974 A1
(43) Pub. Date: Dec. 8, 2022

(54) SYSTEM AND METHOD FOR MICROGRID CONTROL

(71) Applicant: The Research Foundation for The State University of New York, Albany, NY (US)

(72) Inventors: Peng Zhang, Jericho, NY (US); Lizhi Wang, Farmingville, NY (US); Zefan Tang, Stony Brook, NY (US)

(21) Appl. No.: 17/825,416

(22) Filed: May 26, 2022

Related U.S. Application Data
(60) Provisional application No. 63/193,309, filed on May 26, 2021.

(51) Int. Cl. G05F 1/66; H02J 3/06; H02J 13/00

(52) U.S. Cl. CPC G05F 1/66; H02J 3/06; H02J 13/00032; H02J 13/00002; H02J 2203/10; H02J 3/38

(57) ABSTRACT

A software-defined control (SDC)-enabled microgrid system includes a physical plane having multiple distributed energy resources (DERs), the DERs being operatively coupled together via a bus, and a control plane. The control plane includes at least one virtual controller running on a hardware server in the control plane, a system analysis module in communication with the physical plane, and an SDC manager coupled with the virtual controller and the system analysis module. The virtual controller includes multiple software-defined functional modules configured to control prescribed parameters of the microgrid. The system analysis module is configured to generate system analytics information as a function of operational information associated with one or more DERs in the physical plane. The SDC manager is configured to generate one or more virtual controllers for controlling an operation of at least a subset of the DERs in the physical plane as a function of the system analytics information.

### CROSS-REFERENCE TO RELATED APPLICATIONS

This application claims the benefit of U.S. Provisional Patent Application No. 63/193,309, filed on May 26, 2021, entitled “System and Method for Microgrid Control,” the disclosure of which is incorporated by reference herein in its entirety for all purposes.

### STATEMENT OF GOVERNMENT RIGHTS

This invention was made with government support under contract number ECCS2018492 awarded by the National Science Foundation. The government has certain rights in the invention.

### BACKGROUND

The present invention relates generally to the electrical, electronic and computer arts, and, more particularly, to a system and method for microgrid control.

Microgrid is a paradigm shifting solution which enhances electricity resiliency and supports the ever-increasing integration of distributed energy resources (DERs) and energy storage at grid edges. However, it is often prohibitively difficult to build and operate a microgrid due primarily to the hardware dependence of microgrid protection, automation and control (PAC) where the microgrid intelligence resides. Especially, the existing microgrid control is typically implemented on specific hardware, such as a digital signal processor (DSP) or programmable logic controller (PLC), making it difficult and costly to evolve and update when the microgrid configuration changes and thus the controller parameters require re-tuning.

In conventional practice, the high capital expenditures (CAPEX) and operating expenditures (OPEX) associated with hardware controllers multiplying the large number of DERs prohibit nearly any redundancy or backup in microgrid controllers. Consequently, any failure in the microgrid controller can lead to severe impacts on both the microgrid and main grid. Adding to those challenges is the fact that there is no universally applicable tool for designing microgrid control efficiently and optimally, making the designing and deployment of new hardware controllers daunting tasks.

Over the years, despite a large body of literature relating to improving the DER control in microgrids (e.g., droop control, active-reactive power (PQ) control, and voltage-frequency (VF) control), a majority of research efforts only focused on simulation-based performance analysis for control algorithms, assuming a hardware-dependent control architecture. Few of the existing publications address how to improve the response of a microgrid to hardware anomalies such as failures or sabotage.

Recently, software-defined networking (SDN) is attracting increasing attention from the microgrid community as it offers a programmable, flexible and reliable solution to operate the microgrid, supporting diverse quality-of-service (QoS) requirements and making it easier to develop new applications and enable fast innovation in microgrid. However, although a few works have been done on developing SDN-enabled microgrid or even networked microgrids, the existing literature is unfortunately largely silent on the topic of developing software-defined microgrid controls.

### SUMMARY

Principles of the present invention, as manifested in one or more embodiments thereof, are directed to a software-defined control (SDC) system and method for controlling a microgrid. The SDC architecture, according to one or more embodiments of the invention, decouples hardware infrastructure with microgrid control functions.

In one or more embodiments, an exemplary SDC-enabled microgrid system includes a physical plane having multiple distributed energy resources (DERs), the DERs being operatively coupled together via a bus, and a control plane. The control plane includes at least one virtual controller running on a hardware server in the control plane, a system analysis module in communication with the physical plane, and an SDC manager coupled with the virtual controller and the system analysis module. The virtual controller includes multiple software-defined functional modules configured to control one or more parameters of the microgrid. The system analysis module is configured to generate system analytics information as a function of operational information associated with one or more DERs in the physical plane. The SDC manager is configured to generate one or more virtual controllers for controlling an operation of at least a subset of the DERs in the physical plane as a function of the system analytics information.

In accordance with an embodiment of the invention, a software-defined control method for controlling a microgrid includes: initializing a microgrid SDC library included in an SDC manager of a control plane associated with the microgrid; installing one or more software-defined virtual controllers on at least one hardware general computing device in the control plane; and executing the virtual controllers on the general computing device, each of the virtual controllers receiving state information from a corresponding DER residing in a physical plane of the microgrid. Each of the virtual controllers transmits one or more control signals to the corresponding DER for controlling at least one operating parameter of the DER as a function of the state information received from the corresponding DER.

As the term may be used herein, “facilitating” an action contemplates performing the action, making the action easier, helping to carry out the action, or causing the action to be performed. Thus, by way of example only and without limitation, in the context of a processor-implemented method, instructions executing on one processor might facilitate an action carried out by instructions executing on a remote processor, by sending appropriate data or commands to cause or aid the action to be performed. For the avoidance of doubt, where an actor facilitates an action by other than directly performing the action itself, it is assumed that the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps.

Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. By way of example only and without limitation, a microgrid control system and method according to one or more embodiments of the invention may provide one or more of the following feature, among other advantages:
decoupling software from dedicated hardware enables easier modifications, management and updates of the microgrid compared to a solely hardware-based microgrid control approach;
virtualization allows multiple independent users to efficiently use computational and network resources (e.g., processing power and communication bandwidth) by abstracting them into logical units;
a generalized control frame is designed in the SDC architecture which automatically generates controllers for microgrids, providing high reliability and easily-deployable redundancy;
SDC-based microgrid control system provides robust, reliable and plug-and-play capability;
capable of supporting a variety of applications such as secondary and tertiary controls, and other advanced control schemes in microgrid;
provides superior performance when microgrid encounters hardware failures, since new distributed energy resource (DER) controllers can be easily and flexibly defined and deployed, and high redundancy can be provided to handle DER controller and/or other hardware failures;
SDC-based control algorithms can be deployed in Internet of Things (IoT) devices, clouds, local clouds (i.e., fogs), or any distributed computing resources. The flexibility of using an IoT device-based controller provides microgrid controllers with plug-and-play features. The system security and privacy can be better preserved using existing technology for IoT devices.
the SDC-based microgrid control system can be combined with software-defined networking (SDN) to further improve the system's resilience against physical failures, disturbances, and cyberattacks.

These and other features and advantages of the present invention will become apparent from the following detailed description of illustrative embodiments thereof, which is to be read in connection with the accompanying drawings.

### BRIEF DESCRIPTION OF THE DRAWINGS

Non-limiting and non-exhaustive embodiments of the present invention will be described with reference to the following drawings which are presented by way of example only, wherein like reference numerals (when used) indicate corresponding elements throughout the several views unless otherwise specified, and wherein:

FIG. 1 is a block diagram depicting at least a portion of an exemplary software-defined control (SDC)-enabled microgrid architecture, according to one or more embodiments of the present invention;

FIG. 2 is a block diagram depicting at least a portion of an exemplary framework of a generalized distributed energy resource (DER) controller, according to one or more embodiments of the present invention;

FIG. 3 is a block diagram depicting at least a portion of an exemplary SDC work flow, according to one or more embodiments of the invention;

FIG. 4 is a block diagram conceptually depicting at least a portion of an overview of an exemplary implementation process for SDC in microgrid, according to one or more embodiments of the invention;

FIG. 5 is a block diagram depicting at least a portion of an exemplary software-defined microgrid control system, according to one or more embodiments of the present invention;

FIG. 6 conceptually depicts an operation of an exemplary microgrid, wherein active power output of two diesel units in the microgrid is graphed versus time, according to one or more embodiments of the present invention;

FIG. 7 are waveforms conceptually depicting exemplary current and voltage responses of a battery associated with a microgrid before and after the battery is connected into the microgrid, according to one or more embodiments of the present invention;

FIG. 8 conceptually depicts an illustrative current response for a battery in a microgrid when a failure occurs using a hardware-dependent droop controller without a backup controller;

FIG. 9 are waveforms conceptually depicting current and voltage responses for a battery in a microgrid when a failure occurs using master and backup virtual droop controllers running on the same hardware server, according to one or more embodiments of the present invention;

FIG. 10 are waveforms conceptually depicting current and voltage responses for a battery in a microgrid when a failure occurs using master and backup virtual droop controllers running on different hardware servers, according to one or more embodiments of the present invention; and

FIG. 11 is a graph depicting an exemplary performance of a microgrid system with different time delays caused by controller handover between master and backup software-defined controllers running on different hardware servers, according to one or more embodiments of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of the present invention, as manifested in one or more embodiments thereof, will be described herein in the context of an illustrative system, apparatus and/or method for microgrid control. It is to be appreciated, however, that the invention is not limited to the specific system, apparatus and/or methods illustratively shown and described herein. Rather, it will become apparent to those skilled in the art given the teachings herein that numerous modifications can be made to the embodiments shown that are within the scope of the claimed invention. That is, no limitations with respect to the embodiments shown and described herein are intended or should be inferred.

A microgrid is a grouping of distributed energy resources (DERs) with control capabilities and can work in conjunction with the main/primary grid or operate autonomously as dictated by demand and/or other considerations (e.g., cost). It is essentially a smaller version of the grid with several advantages. These advantages include the capability to operate when the main grid is down, a provision of stability in strengthening the grid by reducing grid disruptions, and an increase in efficiency due to the use of local energy sources which mitigate energy losses in the processes of transmission and distribution. Microgrids often use localized renewable energy sources for power generation (e.g., solar panel arrays, wind turbines, etc.), thus making them more environmentally friendly. A microgrid is mostly automated with smart technology and intelligent controls that can anticipate problems and failures and reconfigure itself to account for them. However, it is often prohibitively difficult to build and operate a microgrid due primarily to the hardware dependence of microgrid protection, automation and control (PAC) where the microgrid intelligence resides, which is undesirable.

In order to address one or more problems of conventional microgrids, embodiments of the invention described herein are directed to a novel system and method for microgrid control. More particularly, the system and method provides a software-defined control (SDC) architecture for a microgrid which advantageously virtualizes traditionally hardware-dependent microgrid control functions as software services decoupled from the underlying hardware infrastructure, fully resolving hardware dependency issues and enabling unprecedentedly low costs. That is, the system and method according to aspects of the invention fully decouples the hardware infrastructure from the microgrid control functionality. Decoupling software from dedicated hardware enables easier modifications, management and updates of the microgrid, among other advantages. Virtualization allows multiple independent users to more efficiently utilize computational and network resources (e.g., processing power and communication bandwidth) by abstracting them into logical units. Specifically, the microgrid controllers according to one or more embodiments are implemented in software and run on a computing device or other hardware platform (e.g., general-purpose (i.e., white-box) computer or processing device), preferably via a high-speed network. Extensive experiments in a real-time digital simulator (RTDS) environment verify that virtualization of microgrid controllers beneficially eliminates the restrictions of a hardware implementation while concurrently achieving a goal of hot standby (a redundant method in which one system runs simultaneously with an identical primary system) and seamless switching of controllers at zero cost.

In one or more embodiments, the system and method for microgrid control generates microgrid controllers autonomously in edge computing facilities such as distributed virtual machines (DVMs). Extensive experiments verify that the system and method outperforms traditional hardware-based microgrid control systems, at least in that it facilitates a decoupled cyber-physical microgrid and thus makes microgrid operations unprecedentedly affordable, autonomic and secure.

In certain embodiments, the system and method includes an SDC architecture devised for a microgrid, where the concept and validation of virtualized microgrid controllers are addressed. In certain embodiments, the system and method includes a generalized control frame designed in the SDC architecture, which automatically generates controllers for microgrids, providing high reliability and easily deployable redundancy. In certain embodiments, the system and method decouples the hardware infrastructure with microgrid control functions. Decoupling software from dedicated hardware enables easier modifications, management, and updates.

In some embodiments, SDC-based control algorithms, which may be used by one or more virtual controllers to implement certain microgrid control functions, can be deployed in Internet of Things (IoT) devices. The flexibility of using an IoT device-based controller provides microgrid controllers with plug-and-play features. The system security and privacy can be better preserved using existing technology for IoT devices. The SDC-based microgrid control system can be combined with software-defined networking (SDN) to further improve the system's resilience against physical failures, disturbances, and cyberattacks, in accordance with one or more embodiments. So, for example, when one communication link has a failure or is otherwise under a cyberattack, SDN can be employed to flexibly change to another path.

Compared with conventional microgrid control systems that heavily rely on hardware infrastructure, which is inconvenient and costly to evolve and upgrade, the SDC architecture according to one or more embodiments of the invention described herein provides robustness and plug-and-play capability for DER controllers. It is also capable of supporting a variety of applications such as secondary and tertiary controls, and other advanced control schemes in microgrid. In one or more embodiments, the SDC system is a universal and plug-and-play platform for microgrid, where new DER controllers can be easily and flexibly defined and deployed, and high redundancy can also be provided to handle DER controller failures.

Virtualization, in accordance with one or more embodiments of the invention, provides a beneficial approach to developing novel applications flexibly in microgrid. To implement software-based control functions through virtualization on general-purpose computing devices (e.g., servers, processors, etc.), an important objective is to design a framework for SDC without exhibiting any significant performance degradation. An SDC-enabled microgrid architecture according to one or more embodiments which achieves this objective will now be described.

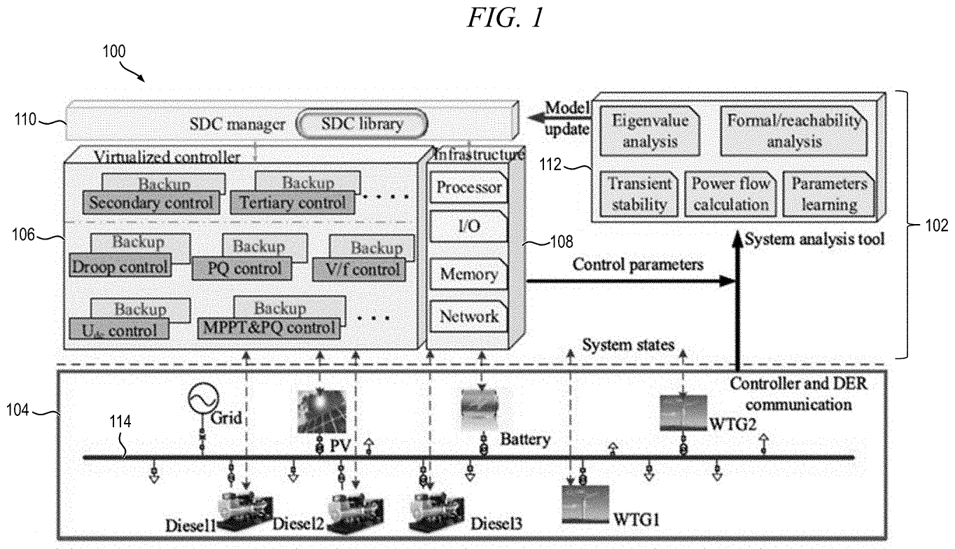

FIG. 1 is a block diagram depicting at least a portion of an exemplary SDC-enabled microgrid architecture 100, according to one or more embodiments of the invention. In the illustrative SDC-enabled microgrid architecture 100, physical and cyber layers are fully decoupled. More particularly, with reference to FIG. 1, the SDC-enabled microgrid architecture 100 is separated into a control plane 102 and a physical plane 104. The control plane 102 and its corresponding functions are pushed to an edge of the microgrid.

The control plane 102 includes one or more virtualized controllers 106, which preferably run on local hardware servers or other hardware infrastructure 108. The virtual controller 106 may, in one or more embodiments, alternatively run on a remote server, as long as it can communicate with DERs in the physical plane 104. Each virtual controller 106, in one or more embodiments, preferably includes several software-defined functional blocks or modules, including, for example, a secondary control module, a tertiary control module, a droop control module, an active-reactive power (PQ) control module, a voltage-frequency (VF) control module, a unit DC (U_{DC}) bus voltage control module, and a maximum power point tracking (MPPT) & PQ control module. The functional modules in the virtual controller 106 are preferably configured to control one or more parameters of the microgrid. In some embodiments, each of at least a subset the respective control modules in the virtual controller(s) 106 preferably includes at least one backup module as a safeguard against failure of the corresponding functional module. The hardware infrastructure 108, on which the virtual controller(s) 106 runs, may include at least one processor, memory coupled with the processor, and one or more interfaces coupled with the processor, such as an input/output (I/O) interface and a network or other communication interface.

The control plane 102 in the exemplary SDC-enabled microgrid architecture 100 further includes an SDC manager 110, which preferably comprises an SDC library, coupled with the virtual controller(s) 106, and a system analysis block or module 112. The system analysis module 112, in one or more embodiments, is configured to perform certain system analytics using information received from various DERs in the physical plane 104. Such analytics functionality is performed by the system analysis module 112 using one or more analysis blocks or modules, including, for example, an Eigenvalue analysis module, a formal/reachability analysis module, a transient stability module, a power flow calculation module, and a parameters learning module. Formal/reachability analysis is used to verify a performance of the microgrid under uncertainties. Microgrids usually incorporate a high penetration of renewables, which brings unprecedented uncertainties to the system operations. In deterministic analytics, only a single scenario is typically considered, which may underestimate the influence of uncertainties or suffer from combinational expansion with a large number of uncertain factors. Reachability analysis generates a series of reachable sets to enclose the uncertain behaviors of the microgrid. Therefore, the formal/reachability analysis module provides an efficient and formal verification of microgrid operations and avoids case-by-case simulation. It is to be appreciated that the functional modules shown in the system analysis module 112 are merely illustrative and non-limiting; rather, the types of analysis modules utilized in the system analysis module 112 will be dependent on the measurement and analysis features desired in the system.

Control parameters generated by the virtual controller(s) 106 and transmitted by the hardware infrastructure 108 are used to control one or more DERs in the physical plane 104, and may also be used by the system analysis module 112. The system analysis module 112, in one or more embodiments, may be further configured to provide model update information to the SDC manager 110 for updating the SDC model library.

In one or more embodiments, the physical plane 104 comprises a grid and a plurality of DERs, such as, for example, solar panels (i.e., photovoltaic (PV) cells), wind turbine generators (WTG) (e.g., WTG1, WTG2), diesel generators (e.g., Diesel1, Diesel2, Diesel3), and battery or other storage units, and possibly smart meters, loads and transformers. Each DER preferably communicates with a corresponding controller through an Internet Protocol (IP)-address-assigned interface, or other communication means, which can adopt different communication protocols to transfer data associated with the corresponding DER, such as control signals and/or analytics information. The various DERs in the physical plane 104 are preferably coupled together via a bus 114 or other connection arrangement.

The measurements obtained from the physical plane 104 (e.g., power generation, load, etc.) are transferred to the control plane 102, and more particularly to the system analysis module 112, via a communication network 116, according to one or more embodiments. These measurements from the physical plane 104 are preferably used for various tasks, such as, but not limited to, eigenvalue analysis (e.g., performed by the eigenvalue analysis module), power flow calculation (e.g., performed by the power flow calculation module), transient analysis (e.g., performed by the transient stability module), formal/reachability analysis (e.g., performed by the formal/reachability analysis module), and parameters learning (e.g., performed by the parameters learning module).

In one or more embodiments, results obtained from the analyses are used for designing control parameters and updating models used by the virtual controller(s) 106. The control parameters and model updates are supplied to the SDC manager 110 by the system analysis module 112. The SDC manager 110, in one or more embodiments, is configured to manage different virtual controllers 106 in the control plane 102, such as by implementing control functions, managing a handover of controllers, and/or providing design parameters for the controllers 106. An important component of the SDC manager 110 is the SDC library, which in some embodiments comprises parameters from a generalized DER controller.

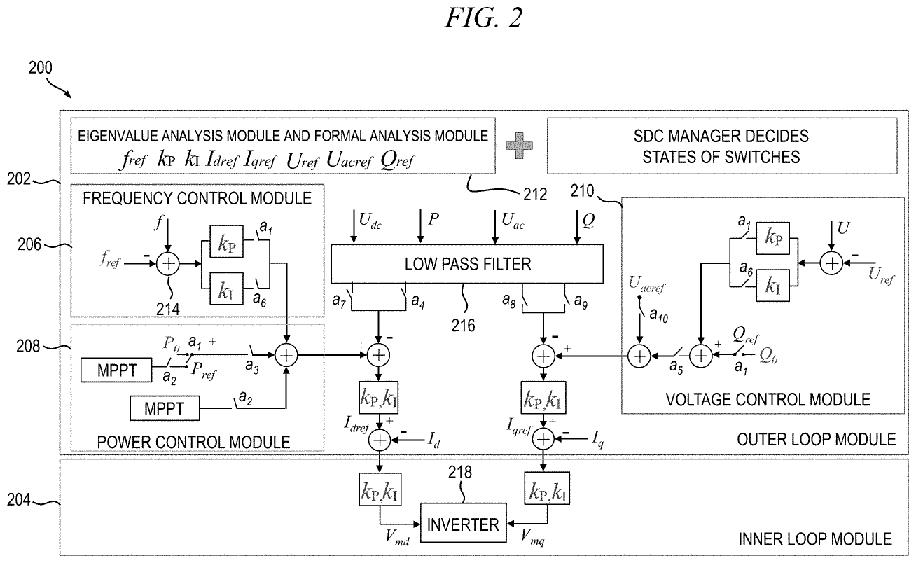

FIG. 2 is a block diagram depicting at least a portion of an exemplary framework of a generalized virtual DER controller 200, according to one or more embodiments of the invention. It is to be understood that the virtual controller 200 described herein is merely illustrative, and that the invention is not restricted to any specific implementation of the virtual DER controller; one skilled in the art may contemplate other architectures for implementing the virtual DER controller that are within the scope of the present invention given the teachings herein. The illustrative virtual DER controller 200 is shown as comprising an outer loop module 202 and an inner loop module 204. The outer loop module 202 includes a frequency control module 206, a power control module 208 operatively coupled with the frequency control module, and a voltage control module 210. These three modules 206, 208 and 210 are used to regulate the frequency, power output and voltages, respectively, of the microgrid(s). A direct outer loop without the inner current control loop can provide a faster and a more robust performance, however, it is unable to limit the current in the DER unit during abnormal conditions; the inner loop is utilized to regulate the inverter currents.

A polymorphic switch ai is used to select the active power reference, P₀, in the power control module 208, and its state is initially off. Each controller's parameters (e.g., f_{ref}, k_{P}, k_{I}, P₀, U_{acref}, U_{ref}, and Q₀, where f_{ref} is the frequency reference, k_{P} is the proportional gain in the PI controller, k_{I}, is the integral gain in the PI controller, P₀ is the active power of a DER working at its equilibrium point, U_{acref} is the voltage reference of the AC side of the converter, and U_{ref} is the voltage reference of the DC side of the converter) are tuned when the controller is created. In the DER controller 200, we just need to input these parameters into the corresponding specific controller (e.g., in the droop control module (see FIG. 1), voltage and frequency reference values and the PI controller gain are provided to regulate the system voltage and frequency). These parameters can be calculated from an Eigenvalue analysis module and formal/reachability analysis module 212, which preferably resides in the system analysis module (112 in FIG. 1). These modules can help calculate the parameters and ensure safe operation of the system. In one or more embodiments, the tuning process is based on an analysis of the system, with the goal of guaranteeing system stability. The combinations of different modules and states of the switches, ai through am, in the DER controller 200 generate different control functions. This characteristic ensures the software-defined controllers inherit from the generalized controller easily.

With continued reference to FIG. 2, the frequency control module 206, in this illustrative embodiment, is configured to receive a measured frequency, f, and a reference frequency, f_{ref}, and generates a signal, f minus f_{ref}, using a first subtractor 214 (i.e., an adder that is configured to subtract one input from another input). The output of the first subtractor 214 is multiplied by either the proportional gain k_{P} or the integral gain k_{I}, which is selected as a function of the state of switches a₁ or a₆, respectively, to generate an output of the frequency control module 206.

In the power control module 208, the active power P₀ and/or a reference power signal, P_{ref}, are combined using a first adder, depending on the state of switches a₁ and a₂, respectively. The output of the frequency control module 206 is supplied to a second adder where it is summed with P₀ and/or P_{ref} and an MPPT signal, depending on the state of switches a₃ and a₂, respectively, to generate an output of the power control module 208.

The output of the power control module 208 is supplied to a third adder configured to subtract filtered parameters unit DC bus voltage, U_{dc}, and/or active power, P, (passed through low-pass filter 216) as a function of switches a₇ and a₄, respectively. The combined output signal from the third adder is multiplied by a gain factor (k_{P} or k_{I}) to generate a signal I_{dref}. A parameter I_{d} is then subtracted from the signal I_{dref} using a fourth adder to generate a first output of the outer loop module 202.

In a similar manner, the voltage control module 210 is configured to combine controller parameters U and the voltage reference of the DC side of the converter, U_{ref}, using a second subtractor to generate a combination signal. This combination signal generated by the second subtractor is multiplied by either the proportional gain k_{P} or the integral gain k_{I}, which is selected as a function of the state of switches a₁ or a₆, respectively. Either the reactive power, Q₀, or a 000000reference reactive power, Q_{ref}, is selected by switch a₁ and summed with the gained combination signal (U−U_{ref}) using a sixth adder. The output generated by the sixth adder is selectively supplied, as a function of the state of switch a₅, to a seventh adder, where it summed with controller parameter U_{acref}, representing the voltage reference of the AC side of the converter, as a function of the state of switch a₁₀, to generate an output of the voltage control module 210.

The output of the voltage control module 210 is supplied to an eighth adder configured to subtract filtered parameters unit AC bus voltage, U_{ac}, and/or reactive power, Q, (passed through low-pass filter 216) as a function of switches a₈ and a₉, respectively. The combined output signal from the eighth adder is multiplied by a gain factor (k_{P} or k_{I}) to generate a signal I_{qref}. A parameter I_{q} is then subtracted from the signal I_{qref} using a ninth adder to generate a second output of the outer loop module 202.

Each of the first and second outputs of the outer loop module 202 are passed through a corresponding gain block to generate signals V_{md} and V_{mq}, respectively. The signals V_{md} and V_{mq} are then supplied to an inverter 218 for controlling power generation therein.

The relationship between the control objective and the respective states of the switches can be described as follows:

c=b·a ,(1)

where c={c₁, c₂, . . . c_{N}} denotes the set of N microgrid controllers, b={b₁, b₂, . . . b_{N}} is the set of binary numbers that control the states of corresponding switches in the N microgrid controllers, and a={a₁, a₂, . . . a₁₀} is the set of ten switches in the exemplary DER controller 200 shown in FIG. 2; for a DER controller having a different number of switches, set a will be matched accordingly. For instance, if bit i of bₙ is a logic one (“1”), switch aᵢ will be turned on to implement the function specified by controller cₙ. In particular, for the droop controller (e.g., droop control module in the virtual controller 106 shown in FIG. 1), the binary number b₁=(1010110010)₂, which means the switches a₁, a₃, a₅, a₆ and a₉ are closed.

DERs typically operate as grid-following sources using the P/Q control when microgrid works in a grid-connect mode. When microgrid works in an islanded mode, some DERs operate as grid-forming sources to actively control their frequency output, making it possible for them to naturally support the system frequency while sharing a portion of the load change. DERs operate as grid-following sources to track the voltage angle of the microgrid to control their output. Table 1 below illustrates certain control configurations of DERs based on the features of the DERs' functions, which provides the specific guidance on how to design DER controllers for SDC users based on a generalized controller. The configuration table is preferably stored in the SDC library of the SDC manager (110 in FIG. 1), which provides SDC manager reference to decide which control module (e.g., PQ control, droop control, V/F control, etc.) should be selected from the library. In one or more embodiments, a backup controller is also established to provide control redundancy for microgrid, as previously stated and as will be discussed in further detail herein below.

TABLE 1

| | | Controllers | |
|---|---|---|---|
| Operations | Inverter Type | (Objectives) | Binary Number |
| Grid-connected | Grid following | P/Q (Control P&Q) | (1100110101)₂ |
| Islanded | Grid forming | Droop (Control f&U) | (0100110101)₂ |
| | | V/f (Control f&U) | (0100100101)₂ |
| | | U_{dc} & U_{ac} | (1111110010)₂ |
| | | (Control U_{dc}&U_{ac}) | |
| | | P & U_{dc} | (1100111001)₂ |
| | | (Control P&U_{dc}) | |
| | Grid following | P/Q (Control P&Q) | (1100110101)₂ |
| | | MPPT & P/Q | (1000110101)₂ |
| | | (Control P&Q) | |

To implement new virtualized control methodologies, flexible computational resources such as memories and processors must be virtualized and allocated to the new controller. This is achieved, in one or more embodiments, using technologies such as Hypervisor or Container by the SDC manager (110 in FIG. 1). Once the new methodology is created, the description on the virtualized controller (106 in FIG. 1) will be stored in the SDC library (residing in the SDC manager 110 in FIG. 1), which contains information including its constitutions and the computational resource requirements. Meanwhile, the communication network resource information such as the bandwidth and delay (i.e., latency) is obtained by the SDC manager via an interface with the communication network, which may reside in the hardware infrastructure (108 in the SDC-enabled microgrid architecture 100 of FIG. 1). New communication channels will be created for new methodologies once the requirements of computational and communication network resources are satisfied. It is to be appreciated that the handshake and communication of different units are managed by the SDC manager, in one or more embodiments.

The SDC architecture according to embodiments of the invention provides the flexibility to develop new applications such as optimization, distributed control and system parameters learning. Based on the demand of microgrid operation, different SDCs can be installed for different DERs. For example, an islanded microgrid needs diesel generators or batteries to stabilize the system frequency, and therefore the software-defined droop controllers can be created to achieve this goal.

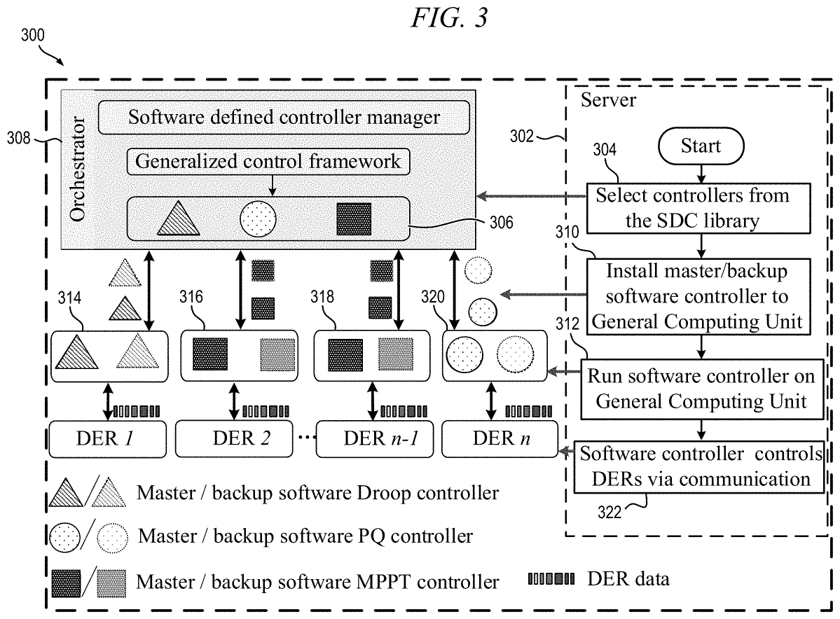

FIG. 3 is a block diagram depicting at least a portion of an exemplary SDC work flow 300, according to one or more embodiments of the invention. In the SDC work flow 300, a server 302 includes at least one processing device configured to perform procedures for implementing the SDCs as follows:
Step 304: Initialize a microgrid SDC library 306 included in an orchestrator module 308 (which comprises an SDC manager and generalized control framework, in some embodiments) by selecting one or more controllers (e.g., virtual droop controller, virtual PQ controller and virtual MPPT controller) from the library, and set the controllers' corresponding parameters based on the requirements of each DER.
Step 310: The SDC manager installs the SDCs on general computing platforms (e.g., servers, in this illustrative scenario). As the controllers are installed in software, one or multiple backup controllers can be optionally installed to provide redundancy. All controllers are installed on servers, which may reside close or far away from the corresponding DERs.
Step 312: Run the virtual controllers on the servers or other general computing units. Each master virtual controller, such as master virtual droop controller 314, master virtual MPPT controllers 316 and 318, and master virtual PQ controller 320, receives state information from its corresponding DER and sends out one or more control signals to the DER for controlling at least one operating parameter of the DER. Meanwhile, each backup controller runs in a “hot standby” mode, which beneficially improves the system's modularity and robustness.
Step 322: An SDC controls its corresponding DER via a data transmission network or other established communication connection (wired or wireless). For instance, information relating to the three phases of the voltage or current from each DER can be transferred to the corresponding controller. In this illustrative scenario, the droop controller 314 is in communication with DER 1, MPPT controller 316 is in communication with DER 2, MPPT controller 318 is in communication with DER n−1, and PQ controller 320 is in communication with DER n, where n is an integer greater than 1. Various encryption protocols can be optionally employed for the data transmission to ensure its reliability and security.

In one or more embodiments, the SDC manager controls the events, including initialization, scaling, termination, and updating. Once the SDC manager detects that a new controller for a certain DER needs to be created, a new connection between the controller and DER will be initialized. This process of instantiating a new controller is autonomous, in one or more embodiments. The SDC manager abstracts the physical resources of each controller and creates the corresponding functions within the virtualized infrastructure (e.g., 108 in FIG. 1). This ensures that the life cycle of each controller is independent of hardware platforms such as the DERs with standardized interfaces between the controllers and DERs. An SDC can run either on a physical server or on a virtual machine (VM), according to embodiments of the invention.

Network protocols such as Transmission Control Protocol/Internet Protocol (TCP/IP) can be used to establish low-latency and loss-tolerating connections between DERs and corresponding controllers. To guarantee the performance of DER controls, the allowed time delay of communication between DERs and controllers should be within tens of microseconds, which can be achieved using existing widely-used network switches.

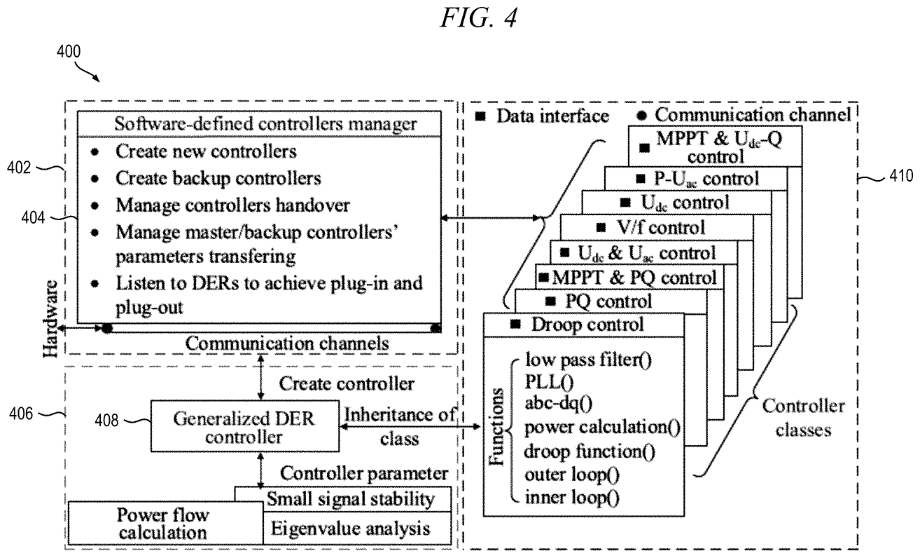

FIG. 4 is a block diagram conceptually depicting at least a portion of an overview of an exemplary implementation process 400 for SDC in microgrid, according to one or more embodiments of the invention. With reference now to FIG. 4, the implementation process 400 comprises three primary components. A first component 402 is the implementation of the SDC manager 404. The SDC manager 404, in one or more embodiments, is preferably configured to create new master and backup controllers, manage controller handovers, transfer parameters for master and backup controllers, and monitor DERs for plug-in and plug-out functionalities. In some embodiments, the plug-in and plug-out functionality is preferably dynamically performed by the SDC manager 404 in real-time, based on prescribed system operating parameters.

A second component 406 of the implementation process 400 for SDC in microgrid is the establishment of a generalized DER controller 408 comprising a library of controller functions. This DER controller library is configured to create (i.e., instantiate) different virtual DER controllers. A variety of controllers may share some common functions, which can be inherited from the generalized DER controller 408, such as, for example, phase lock loop (PLL), coordinate transformation, low pass filtering, and double-loop control functionality.

A third component 410 of the implementation process 400 for SDC in microgrid is the virtualization of SDCs, which can be designed as controller classes based on prescribed characteristics of object-oriented programming (OOP), and are inherited from the generalized DER controller 408. For example, DER controllers that may be created by the generalized DER controller library may include, but are not limited to, the following controller classes: droop control; PQ control; MPPT and PQ control; U_{ac} and U_{dc} control; V/f control; U_{dc} control; P-U_{ac} control; and MPPT and U_{dc}-Q control. Each of the DER controllers will incorporate one or more functions (either common functions or specifically-tailored functions) from the generalized DER controller 408 depending on the specific requirements of its corresponding DER. For example, a droop controller may include the following functions: low pass filter( ); PLL( ); abc-dq( ); power calculation( ); outer loop( ); and inner loop( ). The function abc-dq( ) represents a technique that uses a Park transformation to transform a three-phase (abc) signal to a dq0 rotating reference frame.

Communications between DERs and virtual controllers are managed by the SDC manager 404. Specifically, in one or more illustrative embodiments, when the SDC manager 404 receives a request for creating a new controller for a DER, the function create_new_controller is executed. The IP address and port of the DER are sensed by the SDC manager 404, and the IP address and port of the general computing unit (GCU), on which the newly created DER controller is implemented, are transferred to the DER. Meanwhile, the SDC manager 404 sends commands to the generalized DER controller 408 to request a new controller class. The newly created DER controller then enters a listening mode after being initialized and connected to the corresponding DER. In this state, the DER controller is configured to receive any data packet whose destination IP address and port match the DER controller, respectively. Once a packet arrives, the DER controller begins to send corresponding control signals to the DER. For example, when the SDC manager 404 receives a request from a battery storage DER, a software-defined droop controller is created from the generalized DER controller 408, and corresponding control signals are generated. The server or other processing device, on which the newly created virtual DER controller is being executed, then enters a sending mode and starts to send out control signals whose destination IP address and port are the IP address and port of the DER, respectively.

In one or more embodiments, a handover function is executed by the SDC manager 404 when the SDC manager detects that one DER controller has stopped working. In this instance, the IP address and port of that DER controller that has stopped working is transferred to a backup DER controller, and the corresponding control parameters will also be set for the backup DER controller.

Virtualized controllers running on commodity hardware preferably use virtualized computational resources to facilitate the implementation of the SDC framework. A virtualized controller has the ability to produce optimal results with minimum resources. Integrating the intervention into existing structures greatly requires the replacement of existing controllers with virtualized resources and the establishment of connections between virtualized controllers and DERs. Compared to existing hardware-dependent control architectures, an SDC architecture according to embodiments of the invention offers multiple benefits for microgrid including the following:
The separation of software from hardware infrastructure allows the software to evolve independently, which provides microgrid with great flexibility such as the flexible deployment of control functions for different requirements in microgrid.
The dynamic service provided by the SDC manager offers more intensive monitoring for controllers.
The generalized DER control framework offers a high efficiency and great convenience to develop specific new controllers for DERs.
The convenient creation and deployment of software-defined backup controllers provide high reliability for microgrid to operate with redundancy.

The communication process between a DER and a virtual controller can be summarized as follows: (i) the controller establishes communication with the DER using information provided by the SDC manager; (ii) on the DER side, measurements such as three phases of the output current and voltage of the DER are sampled and transferred to the controller; and (iii) control signals such as those used to generate sinusoidal pulse width modulation (SPWM) are sent back to the DER.

In one or more embodiments, discrete control algorithms deployed in the processor are the main components used to operate the DER controllers. Different distributed discrete secondary control approaches have been proposed in literature to minimize frequency and voltage deviations and ensure accurate active and reactive power sharing for either radial- or mesh-structured microgrids. (See, e.g., X. Lu, et al., “A Novel Distributed Secondary Coordination Control Approach for Islanded Microgrids,” IEEE Trans. Smart Grid, vol. 9, no. 4, pp. 2726-2740, July 2018; W. Gu, et al., “A Nonlinear State Estimator-based Decentralized Secondary Voltage Control Scheme for Autonomous Microgrids,” IEEE Trans. Power Syst., vol. 32, no. 6, pp. 4794-4804, November 2017; J. Schiffer, et al., “Voltage Stability and Reactive Power Sharing in Inverter-based Microgrids with Consensus-based Distributed Voltage Control,” IEEE Trans. Control Syst. Technol., vol. 24, no. 1, pp. 96-109, January 2016, the disclosures of which are incorporated by reference herein in their entireties). However, the primary discrete controllers are not addressed in any literature.

A discrete-time mathematical model and an analytical framework for a droop-controlled inverter-based microgrid are presented in M. B. Delghavi, et al., “An Adaptive Feedforward Compensation for Stability Enhancement in Droop-controlled Inverter-based Microgrids,” IEEE Trans. Power Del., vol. 26, no. 3, pp. 1764-1773, July 2011, the disclosure of which is incorporated herein by reference in its entirety, where the double-loop controllers are not included. Moreover, the PI regulator is shown using the z-transformation, which however cannot be applied directly for software evolutions. One or more embodiments of the invention beneficially provide a droop controller considering the power calculation, frequency control, and voltage-current loop control, which is described in detail using the trapezoidal rule, that can be directly applied with the software. Discrete models for other controllers, such as PQ and V/f controls, can be generated in a similar manner, as will become apparent to those skilled in the art given the teachings herein.

More particularly, for a droop control, frequency and voltage magnitudes at time k can be obtained as follows:

f(k)=f*−m(P(k)−P*)=f*−mΔP(k), (2)

and

E(k)=E*−n(Q(k)−Q*)=E*−nΔQ(k), (3)

where f(k) and E(k) are the frequency and voltage magnitudes at time k, respectively. P(k) and Q(k) are the discrete samples of the active and reactive powers, respectively. f * and E* are the frequency and voltage references, respectively; and P* and Q* are the active and reactive power references, respectively. ΔP(k) and ΔQ(k) are the corresponding active and reactive power error inputs for the droop controller, and m and n are frequency and voltage droop coefficients, respectively.

For a converter-based DER, the droop control is typically implemented using a double-loop control diagram, where the outer control loop is designed to provide current references for the inner control loop, and the inner loop generates modulation waves for SPWM generation. Let v_{d}(k) and v_{q}(k) be the voltage components in dq coordinate transformed from the three-phase voltage in abc coordinate at time k. Then, Eᵣ(k) can be defined as follows:

$${E}_{r} ( k ) = {v}_{d} ( k ) ( 1 + {\sum }_{n = 1}^{4} {( - 1 )}^{n} \frac{1}{2 n} {Φ}^{2 n} ( k ) ) + {v}_{q} ( k ) ( Φ ( k ) + {\sum }_{n = 1}^{4} {( - 1 )}^{n} \frac{1}{2 n + 1} {Φ}^{2 n + 1} ( k ) ) , \qquad ( 4 )$$

where Φ (k) is the output of the PLL function at time k, and can be calculated recursively as follows:

Φ(k+1)=Φ(k)+(w(k)+w(k+1))T/2, (5)

where T is the sampling time, which is set at 0.2 milliseconds (ms) in this illustrative scenario. w(k) can be calculated recursively as follows:

$$w ( k + 1 ) = {k}_{p} {E}_{r} ( k + 1 ) + {k}_{i} T ( \frac{{E}_{r} ( 0 ) + {E}_{r} ( k + 1 )}{2} + {\sum }_{n = 1}^{k} {E}_{r} ( n ) ) , \qquad ( 6 )$$

where kₚ and kᵢ are the PI parameters.

The phase of the voltage at time k, θ(k), in the discrete domain can be calculated recursively as follows:

θ(k+1)=θ(k)+2π(f(k)+f(k+1))T/2, (7)

where f(k) can be obtained from equation (2) above.

With Eᵣ(k) and θ(k) obtained from equations (4)-(7) above, the error of the input voltage for the outer loop can be calculated as follows:

$$\{ \begin{matrix}Δ {v}_{dref} = {E}_{r} ( k ) ( 1 + {\sum }_{n = 1}^{4} {( - 1 )}^{n} \frac{1}{2 n} {θ}^{2 n} ( k ) ) - {v}_{d} ( k ) ) \\ Δ {v}_{qref} = {E}_{r} ( k ) ( θ ( k ) + {\sum }_{n = 1}^{4} {( - 1 )}^{n} \frac{1}{2 n + 1} {θ}^{2 n + 1} ( k ) ) - {v}_{q} ( k )\end{matrix} \qquad ( 8 )$$

With v_{dref} and v_{qref} obtained from (8), the current references for the inner loop can be calculated as follows:

$$\{ \begin{matrix}{i}_{dref} ( k + 1 ) = {k}_{{pv}_{d}} ( Δ {v}_{dref} ( k + 1 ) ) + {k}_{{iv}_{d}} T ( Δ {v}_{d} ( 0 ) + \frac{Δ {v}_{d} ( k + 1 )}{2} + {\sum }_{n = 1}^{k} Δ {v}_{d} ( n ) ) \\ {i}_{qref} ( k + 1 ) = {k}_{{pv}_{q}} ( Δ {v}_{qref} ( k + 1 ) ) + {k}_{{iv}_{q}} T ( Δ {v}_{q} ( 0 ) + \frac{Δ {v}_{q} ( k + 1 )}{2} + {\sum }_{n = 1}^{k} Δ {v}_{q} ( n )\end{matrix} , \qquad ( 9 )$$

where kₚᵥ_{_{d}}, kᵢᵥ_{_{d}}, kₚᵥ_{_{q}} and kᵢᵥ_{_{q}} are PI parameters, and Δi_{dref}(k) =i_{dref}(k)−i_{d}(k). Then, the voltage modulation references v_{dm} and v_{qm} are obtained as follows:

$$\{ \begin{matrix}{v}_{dm} ( k + 1 ) = {v}_{d} ( k + 1 ) + {k}_{{pi}_{d}} ( Δ {i}_{dref} ( k + 1 ) ) + {k}_{{ii}_{d}} T ( Δ {i}_{d} ( 0 ) + \frac{Δ {i}_{d} ( k + 1 )}{2} + {\sum }_{n = 1}^{k} Δ {i}_{d} ( n ) ) + {i}_{q} ( k + 1 ) wL \\ {v}_{qm} ( k + 1 ) = {v}_{q} ( k + 1 ) + {k}_{{pi}_{q}} ( Δ {i}_{qref} ( k + 1 ) ) + {k}_{{ii}_{q}} T ( Δ {i}_{q} ( 0 ) + \frac{Δ {i}_{q} ( k + 1 )}{2} + {\sum }_{n = 1}^{n} Δ {i}_{q} ( n ) ) - {i}_{d} ( k + 1 ) wL\end{matrix} \qquad ( 10 )$$

where kₚᵢ_{_{d}}, kᵢᵢ_{_{d}}, kₚᵢ_{_{q}}, and kᵢᵢ_{_{q}} are PI parameters, i_{d}(k) and i_{q}(k) are the current components in dq coordinate transformed from the three-phase current in abc coordinate at time k, w is the frequency reference (i.e., 120π), and L is the inductance of the filter in the droop controller.

A variety of functions in a droop control such as inner loop and outer loop, can be used for other software-defined controls. Similar methodologies can be applied for the derivation of discrete models for other software-defined controls such as PQ and V/f controls.

In the SDC architecture according to one or more embodiments of the invention, the flow of information comprises three steps: (i) measurement; (ii) communication among controllers; and (iii) execution. In the measurement process, transmitting the incremental frequency in the f/P droop controller from a DER to a virtualized controller can introduce a time delay, τₘ, in a feedback path. The execution process, in one or more embodiments, uses an interface to send control signals from a virtualized controller to a DER. A control delay, τₑ, which can affect the stability of the distributed system, should be considered. The impact of the control algorithm's iterations in the SDC can be neglected due to the large computing capacity of the SDC. A delay in the closed-loop τ, which is the sum of τₘ and τₑ, forms the total delay of the SDC-enabled microgrid. The small signal model of the time-delayed microgrid is as follows:

$$\{ \begin{matrix}Δ {\dot{x}}_{MG} ( t ) = {A}_{MG 0} Δ {x}_{MG} ( t ) + {B}_{MG 0} Δ {y}_{MG} ( t ) \\ {\sum }_{i = 1}^{S} ( {A}_{MGi} Δ {x}_{MG} ( t - {τ}_{i} ) + {B}_{MGi} Δ {y}_{MG} ( t - {τ}_{i} ) ) \\ 0 = {C}_{MG 0} Δ {x}_{MG} ( t ) + {D}_{MG 0} Δ {y}_{MG} ( t )\end{matrix} , \qquad ( 11 )$$

where τᵢ=τₘᵢ+τₑᵢ(i=1, . . . , m) refers to the time delay constants, and 0<τ₁< . . . <τ₁ [symbol] τₘₐₓ. In the SDC-enabled architecture according to one or more embodiments of the invention, the measurement and execution delays are trivial compared with the switching and communication delays caused by master and backup controllers. The impact of this delay will be discussed in further detail herein below.

### Experimental Results

By way of example only and without limitation, in order to evaluate the performance of the SDC architecture according to an illustrative embodiment of the invention, a real-time testbed was built in an RTDS environment. For this exemplary scenario, the testbed included RTDS hardware, its auxiliary facilities such as gigabit-transceiver network (GTNET) communication cards, which provide a real-time communication link to and from the RTDS simulator via Ethernet, and one or more servers. A console personal computer (PC) was used to develop and compile the microgrid model in RSCAD® (a registered trademark of RTDS Technologies Inc.), a power simulation software designed to interact with the RTDS hardware. The GTNET cards can be used to transmit data between RTDS and external equipment through a local area network (LAN)/wide area network (WAN) using protocols such as, for example, the GTNET-SKT (Socket) protocol. The RTDS hardware and servers are connected through switches and campus network. Meanwhile, each server has a specific port, which is linked to the campus network and can be used for the console PC to access the server. In this experimental evaluation, the simulator in RTDS has 16 cores for physical layer simulation running in real time; it provides Gigabit Ethernet ports for all IP-based communications, including data transmissions between RTDS and external servers.

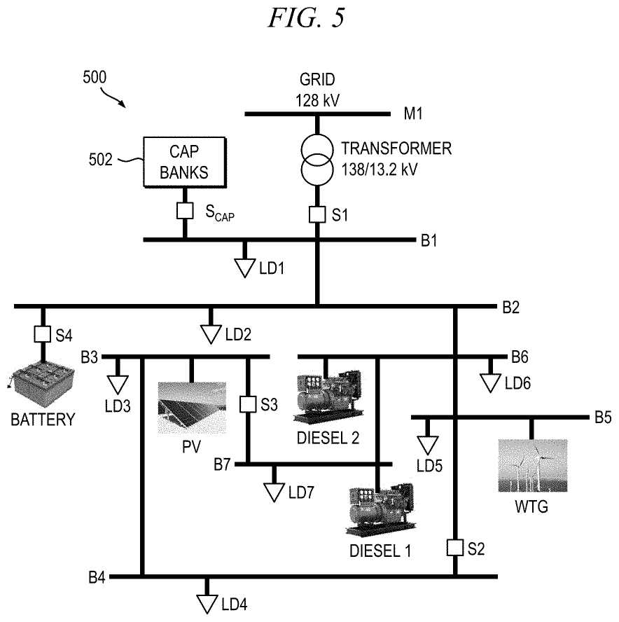

FIG. 5 is a block diagram depicting at least a portion of an exemplary software-defined microgrid control system 500, according to one or more embodiments of the invention. The illustrative system 500 comprises a microgrid including a plurality of buses, B1 through B7, connected to a main bus or grid, M1, via a transformer (e.g., 138/13.2 kV) and corresponding switch or breaker, S1. The microgrid comprises one or more banks of capacitors 502 coupled on a first bus, B1, via a corresponding switch (i.e., breaker), S_{CAP}, a battery coupled on a second bus, B2, via a corresponding switch, S4, a photovoltaic (PV) unit directly coupled on a third bus, B3, a wind turbine, WTG, directly coupled on a fifth bus, B5, and two diesel units, Diesel 1 and Diesel 2, directly coupled on a sixth bus, B6. The microgrid is configured to operate in islanded mode or grid-connected mode, depending on whether the circuit breaker S1 is open or closed, respectively.

Table 2 below provides exemplary three-phase power loads (in KVA) on the different buses. Loads LD1 through LD4 on buses B1 through B4, respectively, are modeled as switched resistive-inductive (RL) passive loads, while loads L5S through LD7 on buses B5 through B7, respectively, are modeled as non-switchable dynamic loads representing the critical loads in the system 500.

TABLE 2

| Bus | Phase A | Phase B | Phase C | Power Factor |
|---|---|---|---|---|
| 1 | 506 | 506 | 506 | 0.9 |
| 2 | 367 | 367 | 367 | 0.95 |
| 3 | 344 | 344 | 344 | 0.9 |
| 4 | 356 | 356 | 356 | 0.9 |
| 5 | 325 | 625 | 100 | 0.95 |
| 6 | 333 | 333 | 333 | 0.95 |
| 7 | 275 | 625 | 150 | 0.95 |

Generation and control schemes for DERs in the exemplary system 500 are summarized in Table 3 below. The diesel units and the battery use droop control to achieve frequency and power sharing when the microgrid operates in islanded mode, while the PV and wind turbine use PQ control.

TABLE 3

| | | Control | | | | | |
|---|---|---|---|---|---|---|---|
| Bus | DER | Method | mₚ | Kₚᵥ | Kᵢᵥ | kₚᵢ | Kᵢᵢ |
| 1 | Cap Banks (0.5) | N/A | N/A | N/A | N/A | N/A | N/A |
| 2 | Battery (0.5) | Droop | 0.6 | 0.1 | 5 | 0.05 | 0.3 |
| 3 | PV (1.74) | PQ | N/A | 1 | 5 | 0.025 | 0.5 |
| 5 | WTG (2) | PQ | N/A | 1 | 10 | 0.3 | 10 |
| 6 | Diesel (3) | Droop | 0.2 | N/A | N/A | N/A | N/A |
| 7 | Diesel (3) | Droop | 0.2 | N/A | N/A | N/A | N/A |

In the simulation, the sampling time step is set at 2 μs for converter-based components and 50 μs for other components in the microgrid. The sampling rate of transmission data is 600 packets per second. A software-defined virtual droop control is designed for the battery in FIG. 5, whose parameters are given in Table 2 above. In this illustrative embodiment, the battery is connected to bus B2 through a 0.48/13.2 kV step-up transformer. As the current constraint is commonly set at 1.1-1.3 times the rated current, a constraint of 1.25 per unit (p.u.) is set for the converter's current for this exemplary evaluation scenario. Per unit is a way of expressing the value of a quantity in terms of a reference or base quantity. In a per unit system, each system variable or quantity is normalized with respect to its own base value. Calculations are simplified because quantities expressed as per unit are the same regardless of the voltage level.

The performance of the illustrative software-defined microgrid control system 500 according to one or more embodiments of the invention was compared with a traditional hardware-based droop controller. In the test case, the two diesel units share the same droop factor and capacity. Diesel 1 is controlled by a software-defined droop controller running on a remote server, and Diesel 2 is controlled by a traditional droop controller, which runs in the RTDS.

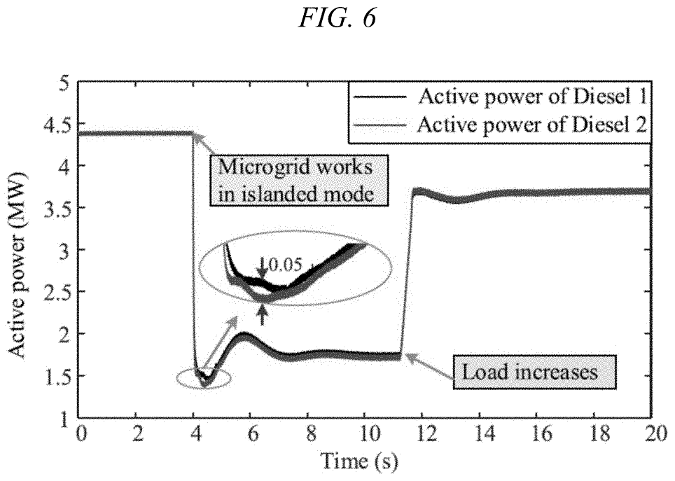

An illustrative operation of the microgrid will now be described in conjunction with FIG. 6, which is a graph depicting active power output (in megawatts (MW)) of the two diesel units in the exemplary microgrid versus time (in seconds (s)), according to one or more embodiments. Initially, the microgrid is connected to the main grid M1, by closing switch S1, and the battery and capacitor banks are disconnected from the microgrid, such as by opening switches S4 and S_{CAP}, respectively (see FIG. 5). With reference to FIG. 6, at time t=4 s, switch S1 is opened, thereby forcing the microgrid to operate in an islanded mode. Meanwhile, the two diesel units (Diesel 1 and Diesel 2) immediately start to regulate their power for balancing power generation with load consumption in the system. At time t=11.5 s, the active power of load LD6, coupled to bus B6 (see FIG. 5), is suddenly increased from 1 MW to 5 MW, which results in the active power of the DER increasing from about 1.75 MW to 3.75 MW.

In comparing results for the active power of the two diesel units shown in FIG. 6, the following observations can be made:
From time t=4 s to around t=7 s, the two diesel units have almost the same dynamic performance. A maximum difference between the active power of the two diesel units is only about 0.05 MW.
At time t=11.5 s, the two diesel units increase their active power to an almost same degree during the regulation of the active power output. This confirms that the software-defined droop controller according to embodiments of the invention performs as well as a traditional hardware-dependent droop controller; there is essentially no performance degradation.

By way of example only and without limitation, consider the impact of an SDC-enabled DER on the software-defined microgrid system according to one or more embodiments of the invention. Initially, when an SDC-enabled DER is plugged into the system, the microgrid operates in an islanded mode with the battery disconnected. At time t=1.2 s, the battery is plugged into the system. Meanwhile, the SDC manager (e.g., 110 in FIG. 1) receives a handshake request and immediately generates and installs a virtual droop controller on the remote server. A new connection is established between the battery and the virtual droop controller. The three phases of voltage and current of the battery's output are sampled by the system and transferred to the virtual droop controller on the server through the campus network. At time t=6.8 s, the active power of load LD6 is suddenly increased from 1 MW to 5 MW.

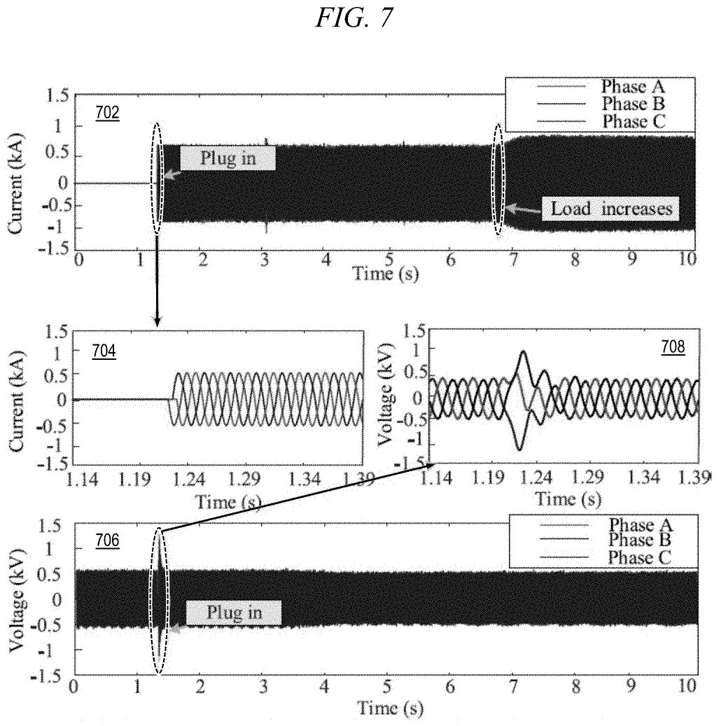

Exemplary current and voltage responses of the battery before and after the battery is connected into the microgrid are illustrated by the waveforms shown in FIG. 7, according to one or more embodiments of the invention. With reference to FIG. 7, the following observations are apparent:
The virtual droop controller immediately starts to control the battery when the battery is connected to the microgrid at time t=1.2 s, as shown in graph pane 702. The current of the battery is stabilized in a very short time, as shown in graph pane 704.
The voltage of the battery has a slight fluctuation, as shown in graphs panes 706 and 708, but becomes stable within only about 0.05 s after the battery is connected to the microgrid, as shown more clearly in graph pane 708.
When load L6 increases at time t=6.8 s, the voltage magnitude of the battery remains constant, as shown in graph pane 706, while the current magnitude of the battery increases, as shown in graph pane 702. This indicates that the SDC-enabled battery has started to participate in the power sharing within the microgrid.

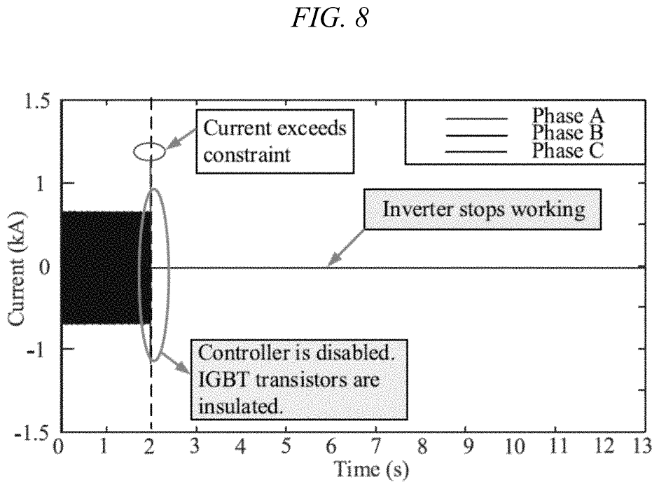

A backup controller can be implemented in microgrid to provide redundancy. For example, as previously stated in conjunction with FIG. 1, the virtualized controllers 106 in the exemplary SDC-enabled microgrid architecture 100, according to one or more embodiments of the invention, preferably include respective backup modules to safeguard against a failure of the corresponding functional controllers. In one or more embodiments, the SDC manager 110 (FIG. 1) is configured to control a transfer of parameters from a given functional module in the virtual controller to a corresponding backup module when a failure event is detected, as part of a handoff procedure between the functional module and its corresponding backup module. The impact of the switching between a master controller and a backup controller running on the same hardware infrastructure (e.g., server) will now be described in conjunction with FIGS. 8-10.

FIG. 8 conceptually depicts an illustrative current response for a battery in a microgrid when a failure occurs using a traditional hardware-dependent droop controller without a backup controller. As apparent from FIG. 8, at time t=2 s, the master controller fails, meaning it cannot process data and achieve the droop function. When the traditional droop controller fails, no control signals are sent back to the battery due to a lack of redundancy. Since there is no feedback control signal, no modulation wave can be used to generate the pulse width modulation (PWM) signals. Insulated-gate bipolar transistors (IGBTs) in the converter are isolated due to an overcurrent (where the current exceeds a prescribed constraint) which occurs at time t=2 s, and the converter simply stops working, as evident by the zero current output generated after time t=2 s.

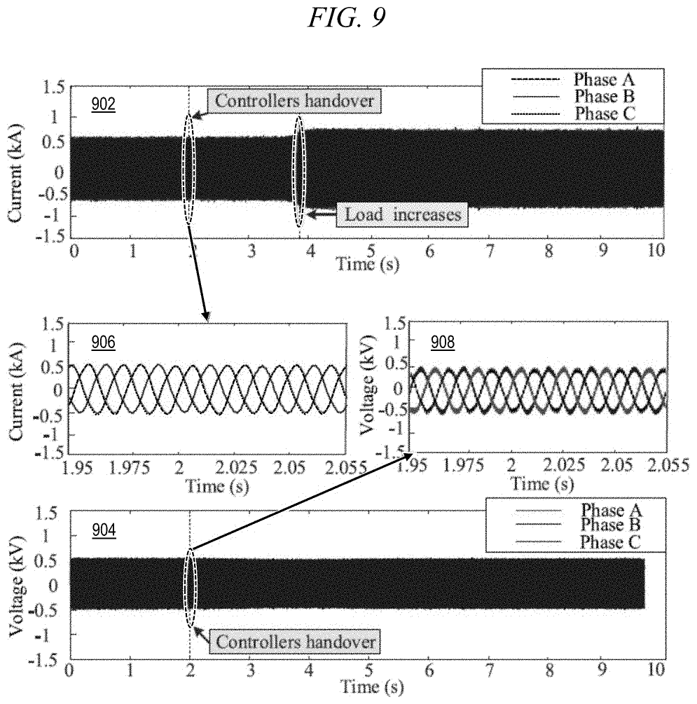

FIG. 9 are waveforms conceptually depicting exemplary current and voltage responses for a battery in a microgrid when a failure occurs using master and backup software-defined (i.e., virtual) droop controllers running on the same hardware server, according to one or more embodiments of the invention. With reference to FIG. 9, at time t=2 s, the master controller fails and the backup controller immediately starts to work. Meanwhile, the new connection between the battery and the backup virtual controller is established. The states of the master virtual controller are transferred to the backup virtual controller, thereby enabling the battery to be controlled by the backup virtual controller. At time t=3.8 s, the active power of load LD6 is adjusted from 1 MW to 5 MW, which results in a slight increase in battery current, as shown in graph pane 902 and essentially no change in battery voltage, as shown in graph pane 904. As apparent from FIG. 9, there are no overcurrent or voltage fluctuation issues, as shown in graph panes 906 and 908, respectively, during handover of the virtual controllers when the virtual controllers are running on the same hardware server.

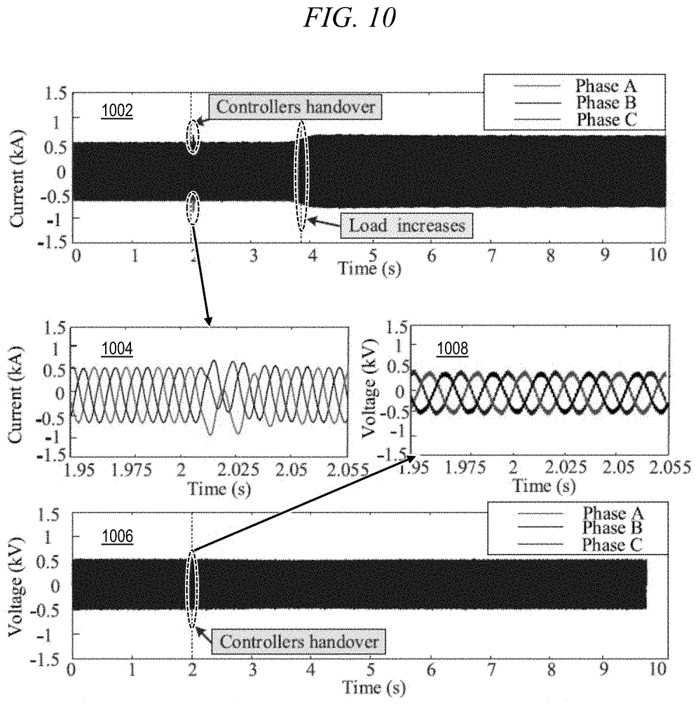

FIG. 10 are waveforms conceptually depicting current and voltage responses for a battery in a microgrid when a failure occurs using master and backup software-defined (i.e., virtual) droop controllers running on different hardware servers, according to one or more embodiments of the invention. Specifically, in this illustrative embodiment it is assumed that the master software-defined droop controller runs on a first hardware server and the backup software-defined droop controller runs on a second hardware server that is different from the first server.

With reference to FIG. 10, at time t=2 s, the master controller on the first server fails. The states of the master virtual controller are then transferred to the backup virtual controller on the second server. Once the state information has been transferred between the master and backup virtual controllers, communication is established between the DER associated with the failed master virtual controller and the corresponding backup virtual controller. During the handover between the master and backup virtual controllers, a magnitude of the battery current becomes slightly higher momentarily, increasing from 0.5 kA to about 0.8 kA, as evident in graph pane 1002, and more clearly shown in graph pane 1004. This is due primarily to a communication latency between the two hardware servers on which the master and backup software-defined droop controllers are running. However, the current disruption is still within prescribed constraints. Meanwhile, a voltage response of the battery during the handover between the master and backup controllers is essentially undetected, as shown in graph pane 1006, and more clearly in graph pane 1008. Thus, embodiments of the invention facilitate normal operation of the microgrid system during the handover between master and backup software-defined droop controllers running on different hardware servers.

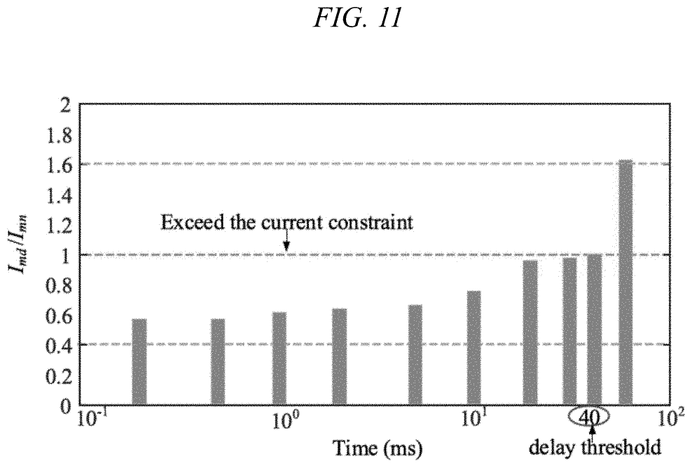

For an SDC-enabled system according to one or more embodiments of the invention, a critical issue is the impact of communication latency on a software-defined controller's performance. Delays caused by measurement, execution, and algorithm iteration can have different impacts on the system's performance. It can be shown that the measurement and execution cause very small delays due to the high rate of data sampling and large communication capability of the test bed. FIG. 11 is a graph depicting an exemplary performance of the microgrid system with different time delays caused by controller handover with the master and backup software-defined controllers running on different hardware servers, according to one or more embodiments of the invention. In this illustrative analysis, the current constraint of the battery is denoted as Iₘₙ, and the maximum current magnitude of the battery during the handover of the controllers with a certain time delay is denoted as I_{md}.

With reference to FIG. 11, it is apparent that the nominal delay caused by the handover between the master and backup controllers in different servers is tolerated, which indicates that the microgrid system remains stable. When different time delays are introduced, the current of the battery is below the constraint of the converter's current when the communication delay is less than a threshold of about 40 ms. By comparison, it should be appreciated that the communication delay of existing Ethernet switches is only about several milliseconds, which is far smaller than the 40 ms delay threshold.

At least a portion of the techniques of the present invention may be implemented in an integrated circuit. In forming integrated circuits, identical die are typically fabricated in a repeated pattern on a surface of a semiconductor wafer. Each die includes a device described herein, and may include other elements, structures and/or circuits. The individual die are cut or diced from the wafer, then packaged as an integrated circuit. One skilled in the art would know how to dice wafers and package die to produce integrated circuits. Any of the exemplary systems and circuits illustrated in the accompanying figures, or portions thereof, may be part of an integrated circuit. Integrated circuits so manufactured are considered part of this invention.

Those skilled in the art will appreciate that the exemplary systems and circuits discussed above, or portions thereof, can be distributed in raw form (i.e., a single wafer having multiple unpackaged chips), as bare dies, in packaged form, or incorporated as parts of intermediate products or end products that benefit from having a microgrid controller formed therein in accordance with one or more embodiments of the invention, such as, for example, an SDC microgrid control system.

An integrated circuit in accordance with aspects of the present disclosure can be employed in essentially any microgrid control application and/or electronic system, particularly microgrid control systems requiring the decoupling of hardware-dependent functionality. Systems incorporating such integrated circuits are considered part of this invention. Given the teachings of the present disclosure provided herein, one of ordinary skill in the art will be able to contemplate other implementations and applications of embodiments of the invention.

The illustrations of embodiments of the invention described herein are intended to provide a general understanding of the various embodiments and are not intended to serve as a complete description of all the elements and features of apparatus and systems that might make use of the module, circuits and/or methods described herein. Many other embodiments will become apparent to those skilled in the art given the teachings herein; other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

Embodiments of the invention are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Locational terms such as “above,” “below,” “in,” “out,” “internal,” and “external,” as may be used herein, are intended to describe the relative position of elements or structures to each other as opposed to an absolute position of the elements or structures.

The corresponding structures, materials, acts, and equivalents of all means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the various embodiments with various modifications as are suited to the particular use contemplated.

The abstract is provided to comply with 37 C.F.R. § 1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus, the following claims are hereby incorporated into the Detailed Description, with each claim standing on its own as separately claimed subject matter.

Given the teachings of embodiments of the invention provided herein, one of ordinary skill in the art will be able to contemplate other implementations and applications of the techniques of embodiments of the invention. Although illustrative embodiments of the invention have been described herein with reference to the accompanying drawings, it is to be understood that embodiments of the invention are not limited to those precise embodiments, and that various other changes and modifications are made therein by one skilled in the art without departing from the scope of the appended claims.

What is claimed is:

1. A software-defined control (SDC)-enabled microgrid system, comprising:
a physical plane including a plurality of distributed energy resources (DERs), the DERs being operatively coupled together via a bus; and
a control plane including: at least one virtual controller running on a hardware server in the control plane, the virtual controller including a plurality of software-defined functional modules configured to control one or more parameters of the microgrid; a system analysis module in operative communication with the physical plane, the system analysis module being configured to generate system analytics information as a function of operational information obtained from at least a subset of the DERs in the physical plane; and an SDC manager coupled with the virtual controller and the system analysis module, the SDC manager being configured to generate one or more virtual controllers for controlling an operation of at least a subset of the DERs in the physical plane as a function of the system analytics information.

2. The microgrid system according to claim 1, wherein the system analysis module comprises at least one of an Eigenvalue analysis module, a formal/reachability analysis module, a transient stability module, a power flow calculation module, and a parameters learning module, and wherein at least a portion of the system analytics information is used by the SDC manager to update an SDC library included in the SDC manager, the SDC library being configured to store prescribed parameters for instantiating each of the virtual controllers based on prescribed requirements of corresponding DERs.

3. The microgrid system according to claim 1, wherein each of at least a subset of the software-defined functional modules in the virtual controller includes at least one backup software-defined module to provide redundancy for safeguarding against failure of a corresponding functional module.

4. The microgrid system according to claim 3, wherein the SDC manager is configured to control a transfer of states from a given software-defined functional module in the virtual controller to a corresponding backup software-defined module when a failure event is detected in the given functional module.

5. The microgrid system according to claim 3, wherein a given software-defined functional module in the virtual controller runs on a first hardware server and the backup software-defined functional module runs on a second hardware server that is different from the first server.

6. The microgrid system according to claim 1, wherein the system analysis module is configured to monitor an operation of at least a subset of DERs in the physical plane, to determine whether the operation of the subset of DERs conforms to prescribed operating requirements of the microgrid, and to generate at least one control signal supplied to the SDC manager for autonomously instantiating one or more virtual controllers as needed to meet the prescribed operating requirements of the microgrid.

7. The microgrid system according to claim 1, further comprising a communication network coupled between the physical plane and the control plane for transmitting measurements regarding an operation of at least a subset of the DERs in the physical plane to the system analysis module in the control plane.

8. The microgrid system according to claim 1, wherein the virtual controller comprises an outer loop module and an inner loop module, the outer loop module including a frequency control module, a power control module operatively coupled with the frequency control module, and a voltage control module, the frequency control module, power control module and voltage control module being configured to regulate a frequency, a power output and a voltage, respectively, of the microgrid.

9. The microgrid system according to claim 1, wherein the SDC manager is configured to instantiate, on the hardware server, one or more virtual controllers as a function of prescribed operating requirements of the microgrid.

10. The microgrid system according to claim 1, wherein the SDC manager comprises a software-defined library coupled with the system analysis module, the software-defined library storing a configuration table for providing the SDC manager reference to select a given control module from the library for implementing a corresponding function associated with an operation of the microgrid.

11. A software-defined control (SDC) method for controlling a microgrid, the method comprising:
initializing a microgrid SDC library included in an SDC manager of a control plane associated with the microgrid;
installing one or more software-defined virtual controllers on at least one hardware general computing device in the control plane; and
executing the virtual controllers on the general computing device, each of the virtual controllers receiving state information from a corresponding distributed energy resource (DER) residing in a physical plane of the microgrid, each of the virtual controllers transmitting one or more control signals to the corresponding DER for controlling at least one operating parameter of the DER as a function of the state information received from the corresponding DER.

12. The method according to claim 11, further comprising the SDC manager instantiating at least one backup virtual controller for each of at least a subset of the one or more software-defined virtual controllers, the backup virtual controller providing redundancy for a corresponding one of the software-defined virtual controllers.

13. The method according to claim 12, further comprising:
the SDC manager receiving status information relating to an operation of each of at least a subset of software-defined virtual controllers for determining whether a failure event has occurred; and
transferring state information associated with a given one of the software-defined virtual controllers determined to have failed to a corresponding backup virtual controller; and
establishing communication between a DER associated with the given virtual controller determined to have failed and the corresponding backup virtual controller to resume operation of the DER.

14. The method according to claim 11, wherein a network protocol is utilized for communication between each of the virtual controllers and the corresponding DER in the microgrid.

15. The method according to claim 11, further comprising:
the SDC manager receiving status information relating to an operation of each of at least a subset of DERs in the microgrid; and
the SDC manager instantiating or removing at least one virtual controller executing on the general computing device as a function of increased or decreased demand in the microgrid.

16. The method according to claim 11, further comprising:
monitoring an operation of at least a subset of DERs in the physical plane to determine whether the operation of the subset of DERs conforms to prescribed operating requirements of the microgrid; and
generating at least one control signal supplied to the SDC manager for autonomously instantiating one or more virtual controllers as needed to meet the prescribed operating requirements of the microgrid.

17. The method according to claim 11, further comprising storing a configuration table in the SDC library of the SDC manager, the configuration table providing the SDC manager reference to decide which virtual control module to select from the SDC library as a function of one or more characteristics of the DERs.

18. A computer program product for controlling a microgrid, the computer program product comprising a non-transient computer readable storage medium having computer readable program code embodied thereon, the computer readable program code, when executed on at least one processing device in the microgrid, causing the processing device:
to initialize a microgrid SDC library included in an SDC manager of a control plane associated with the microgrid;
to install one or more software-defined virtual controllers on at least one hardware general computing device in the control plane; and
to execute the virtual controllers on the general computing device, each of the virtual controllers receiving state information from a corresponding distributed energy resource (DER) residing in a physical plane of the microgrid, each of the virtual controllers transmitting one or more control signals to the corresponding DER for controlling at least one operating parameter of the DER as a function of the state information received from the corresponding DER.

19. An apparatus for controlling a microgrid, the apparatus comprising:
one or more virtual controllers running on a hardware server associated with the apparatus, the virtual controller including a plurality of software-defined functional modules configured to control one or more parameters of the microgrid, the virtual controller being in operative communication with a corresponding distributed energy resource (DER) in a physical plane of the microgrid;
a system analysis module in operative communication with the physical plane, the system analysis module being configured to generate system analytics information as a function of at least one operational information obtained from at least a subset of the DERs and prescribed operating parameters of the microgrid; and
a software-defined control (SDC) manager coupled with the one or more virtual controllers and the system analysis module, the SDC manager being configured to instantiate one or more virtual controllers for meeting the prescribed operating parameters of the microgrid as a function of the system analytics information;

20. The apparatus according to claim 19, wherein the apparatus resides in a control plane of the microgrid and is fully decoupled from the physical plane of the microgrid.
